(19) United States
(12) Patent Application Publication
(10) Pub. No.: US 2006/0282655 A1
(43) Pub. Date: Dec. 14, 2006

(54) COMPUTER PRODUCT FOR NETWORK PRINTING, MOBILE TERMINAL APPARATUS, AND PRINTING SYSTEM

(76) Inventor: Hideki Yanagi, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/419,628

(22) Filed: May 22, 2006

(30) Foreign Application Priority Data
Jun. 10, 2005 (JP) 2005-170883

(51) Int. Cl. G06F 15/177

(52) U.S. Cl. 713/1

(57) ABSTRACT

A computer of a mobile terminal apparatus connected to a network creates print data using a single printer driver. An image forming apparatus, to which the print data is to be transmitted, is specified from among a plurality of image forming apparatuses connected to the network. The print data is transmitted to the specified image forming apparatus via the network.

### CROSS-REFERENCE TO RELATED APPLICATIONS

The present document incorporates by reference the entire contents of Japanese priority document, 2005-170883 filed in Japan on Jun. 10, 2005.

### BACKGROUND OF THE INVENTION

1. Field of the Invention

The present invention relates to a technology for printing data via a network.

2. Description of the Related Art

An image forming apparatus is generally arranged in a predetermined place, and it is necessary for a user to install a printer driver, which corresponds to the image forming apparatus to be used, into a computer, such as a personal computer (PC). Recently, mobile terminal devices that are connectable to a network, such as a notebook PC, a mobile phone, a personal-handyphone-system (PHS) terminal, a computerized personal organizer, and a personal digital assistance, have become widely used, and there is a demand to operate printing by using the mobile terminal apparatuses in a remote place.

A conventional technology for operating the printing by using the mobile terminal apparatuses is disclosed in, for example, Japanese Patent Application Laid-Open No. 2004-255676 and Japanese Patent Application Laid-Open No. 2003-103879. According to the conventional technology, if there is a latest printer driver in the image forming apparatus, the mobile terminal apparatuses can retrieve the latest printer driver from the image forming apparatus, and can command the printing.

However, if the user is out or away from the image forming apparatus and yet the user wants to operate printing, the user often needs to use minimum functions of the image forming apparatus necessary for the printing. Namely, the printer driver is not necessarily to be the latest. If the user needs to install the latest printer driver every time the user operates the printing by using the mobile terminal apparatus, there becomes many printer drives to be installed in the mobile terminal apparatus. As a result, costs for installing the printer drivers get higher and operation efficiencies of installing the printer drivers get worse.

### SUMMARY OF THE INVENTION

It is an object of the present invention to at least partially solve the problems in the conventional technology.

A computer-readable recording medium according to one aspect of the present invention stores therein a computer program for printing data via a network. The computer program causes a computer to execute creating print data; specifying an image forming apparatus to which the print data is to be transmitted, from among a plurality of image forming apparatuses connected to the network; and transmitting the print data to the specified image forming apparatus via the network.

A printing system according to another aspect of the present invention includes a mobile terminal apparatus that is connectable to a network; and an image forming apparatus that receives print data from the mobile terminal apparatus via the network, and performs a printing based on the received print data. The mobile terminal apparatus includes a computer capable of executing creating the print data; specifying an image forming apparatus to which the print data is to be transmitted, from among a plurality of image forming apparatuses connected to the network; and transmitting the print data to the specified image forming apparatus via the network.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining a printing system according to an embodiment of the present invention;

FIG. 2 is a block diagram of a mobile terminal apparatus shown in FIG. 1;

FIG. 3 is a flowchart for explaining a printing process performed by a printer driver of the mobile terminal apparatus;

FIG. 4 is a schematic for explaining a relation between printer drivers of the mobile terminal apparatus and printer languages of image forming apparatuses;

FIG. 5 is a flowchart for explaining a first example of a process of searching an image forming apparatus;

FIG. 6 is a schematic for explaining a display of search result; and

FIG. 7 is a flowchart for explaining a second example of a process of searching an image forming apparatus.

### DETAILED DESCRIPTION OF THE PREFERRED EMBODIMENTS

Exemplary embodiments of the present invention are explained below in detail with reference to the accompanying drawings.

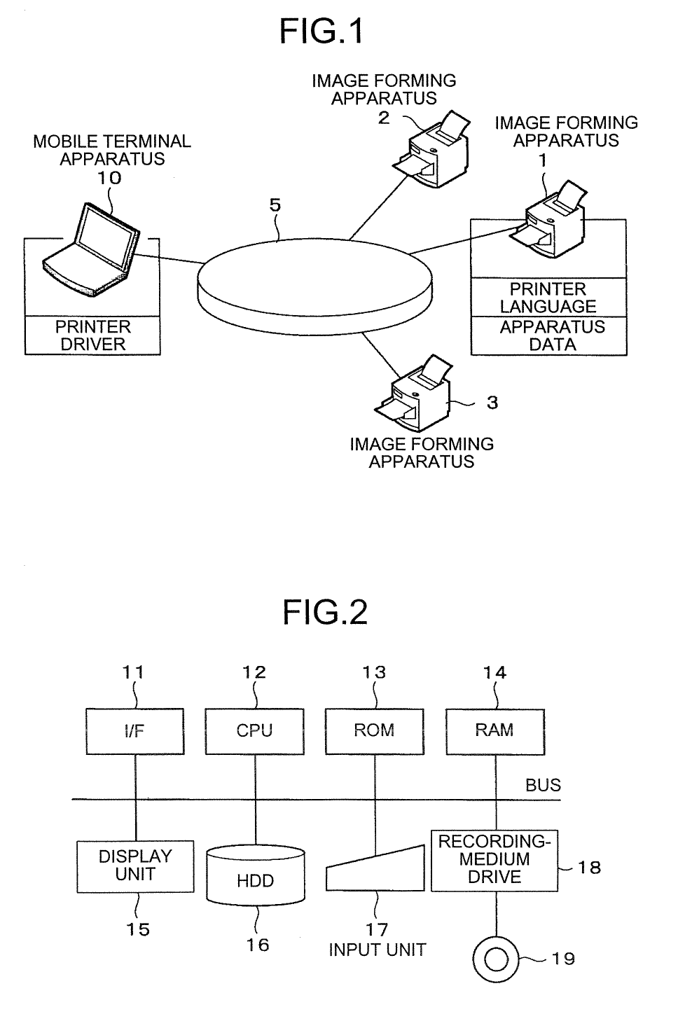

FIG. 1 is a schematic for explaining a printing system according to an embodiment of the present invention. The printing system according to the present embodiment includes a network 5, a mobile terminal apparatus 10 and a plurality of image forming apparatuses 1 to 3 capable of connecting to the network 5. The network 5 is, for example, a local area network (LAN).

The mobile terminal apparatus 10 is generally an information processing apparatus such as a notebook PC, a mobile phone, a PHS terminal, a computerized personal organizer, and a PDA, and performs specific functions when a printer driver (a computer program) according to the present invention is installed and executed therein. The image forming apparatuses 1 to 3 includes printers such as a laser printer, a light-emitting-diode (LED) printer, and an ink jet printer, and image forming apparatuses having a printing function such as a digital copying machine, a digital multi-function product, and a facsimile apparatus. The image forming apparatuses 1 to 3 are capable of printing a visible image on a paper based on print data transmitted from the mobile terminal apparatus 10. Each of the image forming apparatuses 1 to 3 includes a printer language and unique apparatus data. The mobile terminal apparatus 10 can retrieve the printer language and the apparatus data from the image forming apparatuses 1 to 3 by sending a request.

FIG. 2 is a block diagram of the mobile terminal apparatus 10. It is assumed that the mobile terminal apparatus 10 is either a notebook PC or a PDA. The mobile terminal apparatus 10 includes an interface (I/F) 11, a central processing unit (CPU) 12, a read only memory (ROM) 13, a random access memory (RAM) 14, a display unit 15, a hard disk drive (HDD) 16, an input unit 17, and a recording-medium drive 18.

The I/F 11 is a communication tool for relaying a communication between the mobile terminal apparatus 10 and the image forming apparatuses 1 to 3 via the network 5. The CPU 12 controls the mobile terminal apparatus 10. The ROM 13 stores therein predetermined computer programs to be executed by the CPU 12.

The RAM 14 extracts the predetermined computer programs to be executed by the CPU 12 and is used as a work-area for various processing. The display unit 15 includes a cathode-lay-tube (CRT) and a liquid crystal display (LCD) and displays various data or screens necessary for a printing operation. The HDD 16 is a high capacity memory and stores therein computer programs and various data. The input unit 17 includes a keyboard and/or a pointing device, such as a mouse, and is used by a user for inputting data and/or commands.

The recording-medium drive 18 is a recording and replaying unit that records data to and replays data from a recording medium 19.

The recording medium 19 is a removable device such as a magneto-optical (MO) disc, a compact disc-recordable (CD-R), a compact disc-rewritable (CD-RW), a digital versatile disc-rewritable (DVD-RW), a digital versatile disc-recordable (DVD-R), or a digital versatile disk-random access memory (DVD-RAM). Alternately, the recording medium 19 can be a built-in type. The recording medium 19 stores an operation system (OS) and various computer programs (software) including a printer driver and the OS and the computer programs can be retrieved by a computer.

When the user inputs a command from the input unit 17, the CPU 12 retrieves the OS and the computer programs from the recording medium 19 by using the recording-medium drive 18 and installs the OS and the computer programs into the HDD 16. Then, when the mobile terminal apparatus 10 is booted, the CPU 12 retrieves the printer driver, the OS, and other computer programs installed in the HDD 16 according to a boot loader (boot program) in the ROM 13 and executes the printer driver, the OS, and other computer programs according to need. Further, the CPU 12 realizes such functions as creating print data, specifying an image forming apparatus, transmitting the print data, searching the image forming apparatus, displaying search result, and receiving data about the image forming apparatus by using the I/F 11.

When the user is out or away from any image forming apparatuses and uses the mobile terminal apparatus 10, if the user specifies any one image forming apparatus connected to the network 5 and sends a command to start printing, the printer driver creates the print data and transmits the print data to the specified image forming apparatus via the network 5. Then, the print data is printed on a paper. Although, technically speaking, the CPU 12 executes processing according to the computer programs (software), it is assumed here that the computer programs execute the processing.

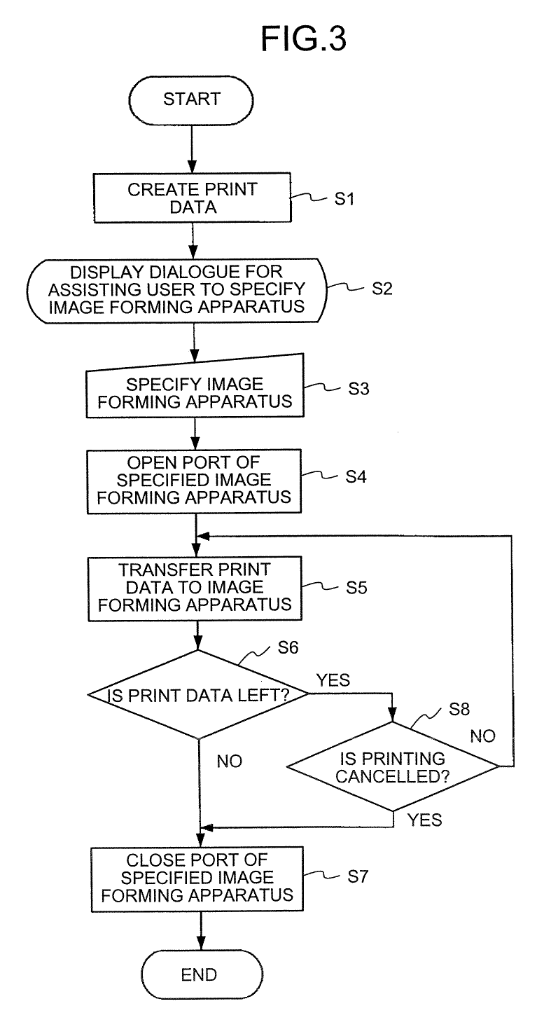

FIG. 3 is a flowchart for explaining a printing process performed by a printer driver of the mobile terminal apparatus 10. When the user sends a command to start printing, the printer driver starts processing, creates print data (step S1), and displays a dialogue on the display unit 15 for assisting the user to specify any one image forming apparatus (step S2).

When the dialogue is displayed on the display unit 15, the user specifies any one of the image forming apparatuses 1 to 3 based on unique IP addresses or unique host names for performing a printing operation (step S3). Then, when any one of the image forming apparatuses 1 to 3 is specified, the printer driver of the mobile terminal apparatus 10 opens a port of the specified image forming apparatus (step S4), writes the print data into the port, and transmits the print data to the specified image forming apparatus via the network 5 (step S5). Then, the print data is printed on a paper.

The printer driver continues to write the print data into the port until all the print data is transmitted to the specified image forming apparatus (steps S5, S6, S8). If all the print data is transmitted to the specified image forming apparatus, the printer driver closes the port and finishes the printing operation (steps S6, S7). If the printing is cancelled by the user during an operation, the printer driver stops writing the print data, closes the port, and finishes the printing operation (steps S7, S8).

Alternately, at step S3, the user can specify a printer language such as postscript or Hewlett-Packard printer control language (HP-PCL). If a printer language is specified in the mobile terminal apparatus 10, the printer driver transmits the print data only to image forming apparatuses having the specified printer language.

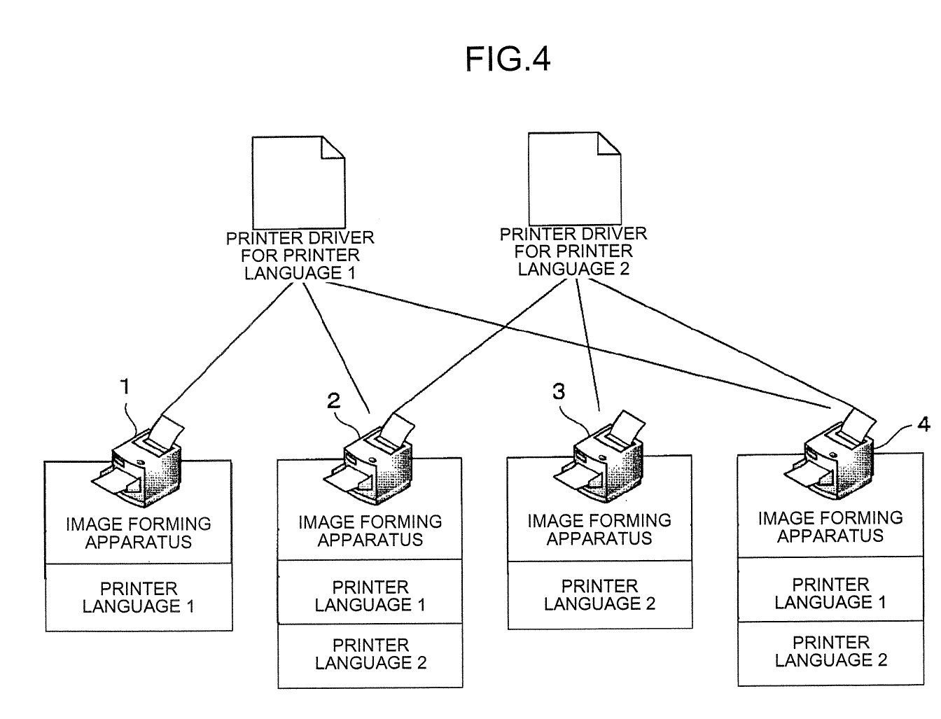

FIG. 4 is a schematic for explaining a relation between printer drivers of mobile terminal apparatuses and printer languages of image forming apparatuses. When there exist an image forming apparatus with a printer language specified by the user, it becomes possible for the user to install only one printer driver corresponding to the specified printer language to the mobile terminal apparatus 10 without installing a plurality of printer drivers with respect to each of image forming apparatuses 1 to 4 and send the print data to that image forming apparatus to print the print data. In FIG. 4, the image forming apparatus 4 is shown in addition to the image forming apparatuses 1 to 3.

Alternately, a configuration can be employed, so that upon receiving a search request from the user for an image forming apparatus that is connected to the network 5 and capable of printing the print data, a printer driver in the mobile terminal apparatus 10 can search the image forming apparatus corresponding to the request from the user by using a broadcast.

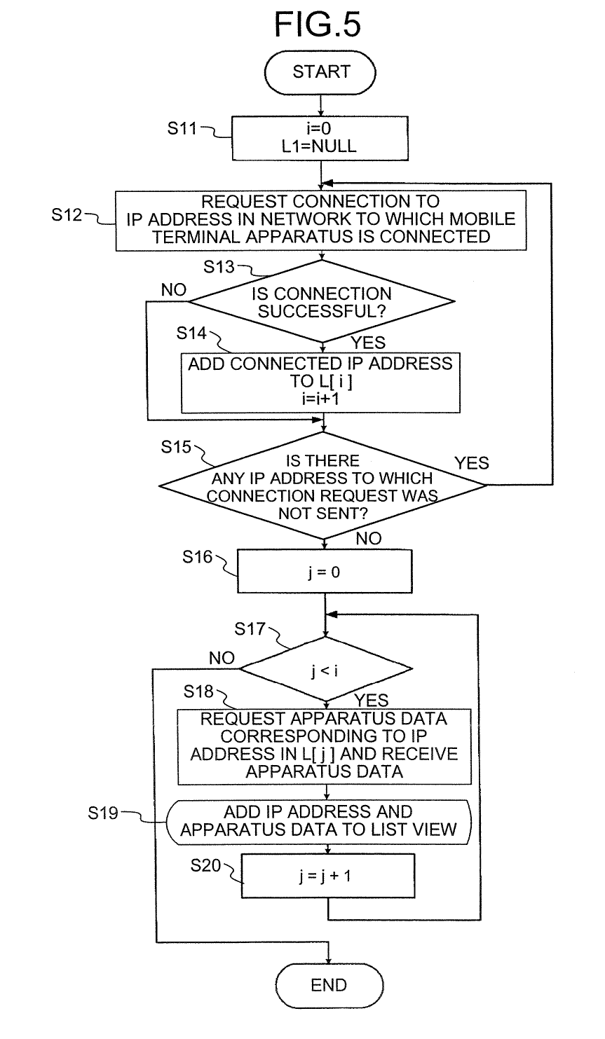

FIG. 5 is a flowchart for explaining a first example of a process of searching the image forming apparatus.

When the user sends a command to search the image forming apparatuses capable of printing the print data, the printer driver starts processing and initializes a list L1 for storing search results (step S11). Then the printer driver sends a connection request to an IP address in the network 5 to which the mobile terminal apparatus 10 is connected (step S12). If the connection request is successful, the printer driver adds the IP address to the list L1 (steps S13, S14). The printer driver continues the above processing until the connection request is sent to every IP address in the network 5 and receives the search results (steps S12 to S15). As a result, all the available image forming apparatuses can be listed up in the list L1.

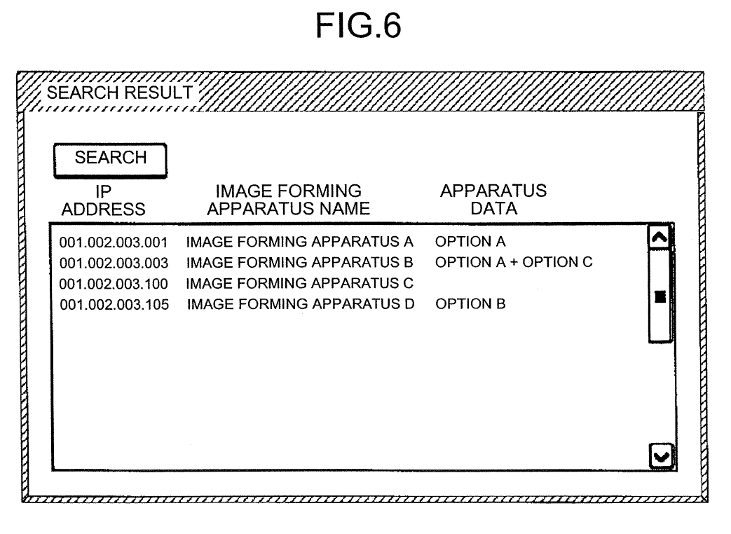

Alternately, the printer driver can retrieve apparatus data unique to each image forming apparatus via an interactive communication and, upon displaying the IP addresses in the list L1 on the display unit 15, the printer driver displays the apparatus data in addition to the IP addresses. More specifically, the printer driver can retrieve names or option data of image forming apparatuses by using such apparatus data as management information base (MIB) (steps S16 to S20) and displays the retrieved data in a list box shown in FIG. 6.

Alternately, upon searching the image forming apparatuses, the user can set detailed search criteria for searching specific image forming apparatuses that fit an intended use.

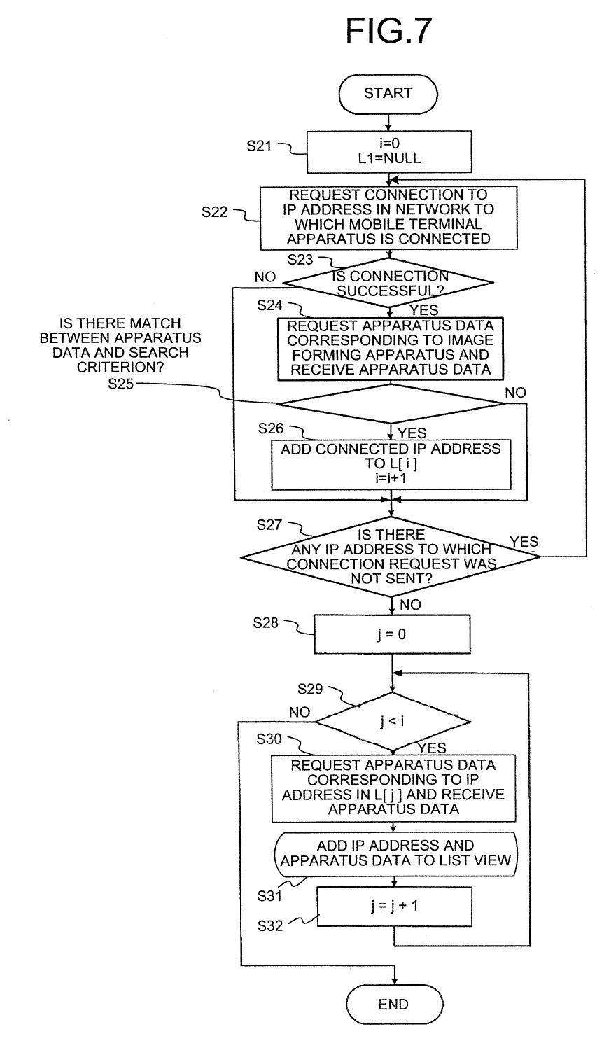

FIG. 7 is a flowchart for explaining a second example of a process of searching the image forming apparatus.

Although the process is generally the same as the process shown in FIG. 5 (steps S21 to S23, S27 to S32), the following steps are new in the process shown in FIG. 7. When the printer driver detects the IP addresses that are successfully connected to the printer driver via a broadcast, the printer driver sends a request for retrieving apparatus data to the connected image forming apparatuses and receives the apparatus data including information of optional structure, such as a reverse printing for printing on both sides of a paper, which is in an active state for being used (step S24).

Then, the received apparatus data is verified if the detected optional structure matches with the search criteria specified and input by the user from the input unit 17, and if there is a match, the corresponding IP addresses are added to the list L1 (steps S25, S26). Namely, the user can customize the search criteria according to the intended use.

According to an embodiment of the present invention, the information processing apparatus connected to the network can be used by the user for specifying any one image forming apparatus, connected to the same network of the information processing apparatus, by sending a command from the information processing apparatus. Namely, it is possible to command printing by using a specific printer driver, which results in cutting a cost of preparing latest printer drivers and improving operational efficiencies of installing the printer driver.

Furthermore, according to an embodiment of the present invention, the image forming apparatus having at least one printer language corresponding to the printer language installed in the information processing apparatus can be specified by verifying the correspondence of the printer languages so that one printer driver can be effectively used for various image forming apparatuses.

Moreover, according to an embodiment of the present invention, when the user is out or away from the image forming apparatus and has no information about where the image forming apparatus is placed, the information processing apparatus can search the image forming apparatuses via a broadcast and can display the search results so that the user can operate the printing by using any one detected image forming apparatus. Furthermore, according to the present invention, the information processing apparatus can retrieve the apparatus data of the detected image forming apparatus via the interactive communication and can display the apparatus data in addition to the search results so that the user can specify the image forming apparatus according to an intended use.

Moreover, according to an embodiment of the present invention, the search criteria such as functions or data of the image forming apparatus can be set, and by using the search criteria, the specific image forming apparatus can be detected according to the processing of the CPU in the information processing apparatus so that the user can specify the image forming apparatus according to an intended use.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that stores therein a computer program for printing data via a network, wherein
the computer program causes a computer to execute:
creating print data;
specifying an image forming apparatus to which the print data is to be transmitted, from among a plurality of image forming apparatuses connected to the network; and
transmitting the print data to the specified image forming apparatus via the network.

2. The computer-readable recording medium according to claim 1, wherein
the computer program further causes the computer to execute specifying a printer language corresponding to the print data, and
the transmitting includes allowing transmission of the print data to an image forming apparatus in which the specified printer language is installed.

3. The computer-readable recording medium according to claim 1, wherein
the computer program further causes the computer to execute:
searching the image forming apparatuses connected to the network by using a broadcast; and
displaying a search result obtained at the searching.

4. The computer-readable recording medium according to claim 3, wherein
the computer program further causes the computer to execute receiving information relating to the searched image forming apparatuses via a bidirectional communication, and
the displaying includes displaying the received information with the search result.

5. The computer-readable recording medium according to claim 4, wherein
the searching includes searching an image forming apparatus having requested information from among the image forming apparatuses connected to the network.

6. A printing system comprising:
a mobile terminal apparatus that is connectable to a network; and
an image forming apparatus that receives print data from the mobile terminal apparatus via the network, and performs a printing based on the received print data, wherein
the mobile terminal apparatus includes a computer capable of executing:
creating the print data;
specifying an image forming apparatus to which the print data is to be transmitted, from among a plurality of image forming apparatuses connected to the network; and
transmitting the print data to the specified image forming apparatus via the network.

7. The printing system according to claim 6, wherein
the computer further executes specifying a printer language corresponding to the print data, and
the transmitting includes allowing transmission of the print data to an image forming apparatus in which the specified printer language is installed.

8. The printing system according to claim 6, wherein the computer further executes:
searching the image forming apparatuses connected to the network by using a broadcast; and
displaying a search result obtained at the searching.

9. The printing system according to claim 8, wherein
the computer further executes receiving information relating to the searched image forming apparatuses via a bidirectional communication, and
the displaying includes displaying the received information with the search result.

10. The printing system according to claim 9, wherein
the searching includes searching an image forming apparatus having requested information from among the image forming apparatuses connected to the network.
